(19) United States
(12) Patent Application Publication
(10) Pub. No.: US 2009/0190353 A1
(43) Pub. Date: Jul. 30, 2009

(54) MODULAR DISPLAY SYSTEM

(76) Inventor: Tom Barker, London (GB)

Correspondence Address: LUEDEKA, NEELY & GRAHAM, P.C., P O BOX 1871, KNOXVILLE, TN, 37901, US

(21) Appl. No.: 11/909,279

(22) PCT Filed: Mar. 22, 2006
(86) PCT No.: PCT/GB2006/001041

§ 371 Date: May 15, 2008

(30) Foreign Application Priority Data
Mar. 22, 2005 (GB) 0505857.3

(51) Int. Cl. F21V 21/00; F21S 4/00

(52) U.S. Cl. 362/249.14; 362/227

(57) ABSTRACT

A modular display system (10) which can be used in a variety of environments for displaying informational signage, advertising, relaying TV images, art installations and so on. The modular display system (10) comprises a fascia assembly (12) comprising an array (16) of light transmitting cells (18) and an illumination assembly (14) comprising an array of light sources (32). In use each of the light sources (32) is alignable with a cell (18) of the fascia assembly. The modular display system (10) further comprises a processor (34) controlling the light sources (32). The cells (18) of the array (16) are hexagonal and at the edges of each fascia assembly (12) the cells (18) are cut along a line which bisects two adjacent or opposite non-parallel walls of each cell (18).

The present invention relates to a modular display system which can be used in a variety of environments for displaying informational signage, advertising, relaying T.V. images, art installations and so on. The modular characteristics provide flexibility in terms of shape and size of the display, to suit a variety of applications.

It is known to provide visual displays made up of an array of pixels, with each pixel being created by a light source such as a light emitting diode (LED), or the end face optical fibre. However, such displays suffer from a number of disadvantages. The angle at which the display can be viewed and the distance from which it can be viewed in order to see a reasonably coherent and legible image are relatively limited. The optical performance and legibility, even when viewed within the preferred ranges, is not particularly great since the image tends to appear as dots of colour on a black background. Such visual displays require additional modification at great expense in order to make them weatherproof for use outdoors and such systems have limited load bearing capacities and cannot be used as structural members.

It is also known to use an array of CRT, plasma or LCD screens covered by thick glass sheets to produce a large display. However, the size and shape of the display is still limited and the overall image produced is disrupted by the relatively thick edges to the individual screens.

The present invention provides a modular display system comprising at least one fascia assembly comprising an array of light transmitting cells, and at least one illumination assembly comprising an array of light sources each alignable with a cell of the fascia assembly in use and a processor controlling the light sources, wherein the cells of the array are hexagonal and at the edges of the or each fascia assembly the cells are cut along a line which bisects two adjacent or opposite, non-parallel walls of each cell.

In this way, adjacent illumination assemblies can be fitted together seamlessly. Each cut cell in one illumination assembly will correspond to a cut cell of an adjacent assembly to re-form a hexagonal cell.

The present invention will now be described in detail, by way of example only, with reference to the accompanying drawings in which:

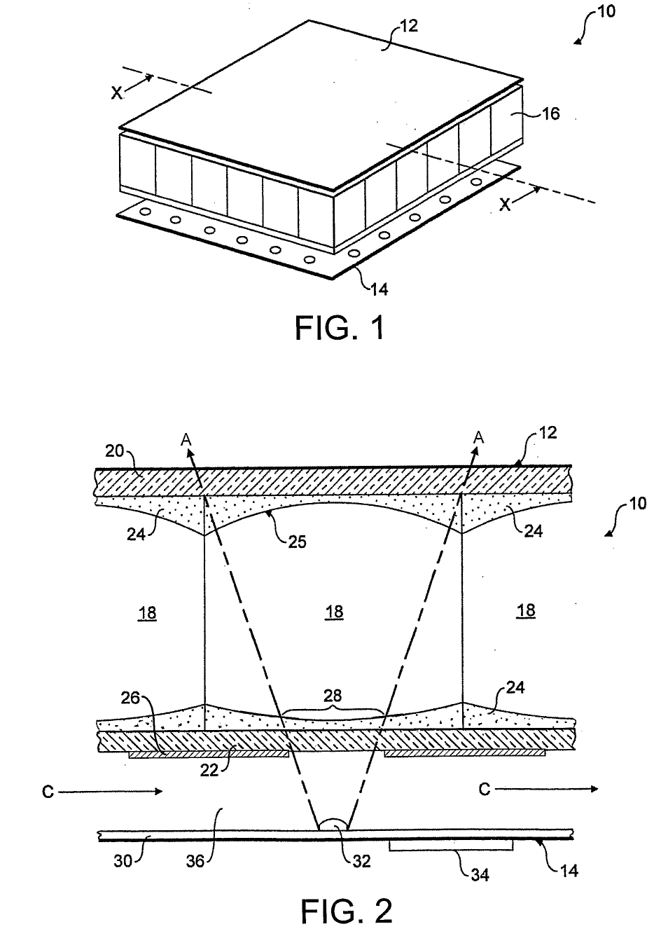

FIG. 1 is a schematic perspective view of a portion of a modular display system in accordance with a first embodiment of the present invention;

FIG. 2 is a cross-section of part of FIG. 1 along the line XX;

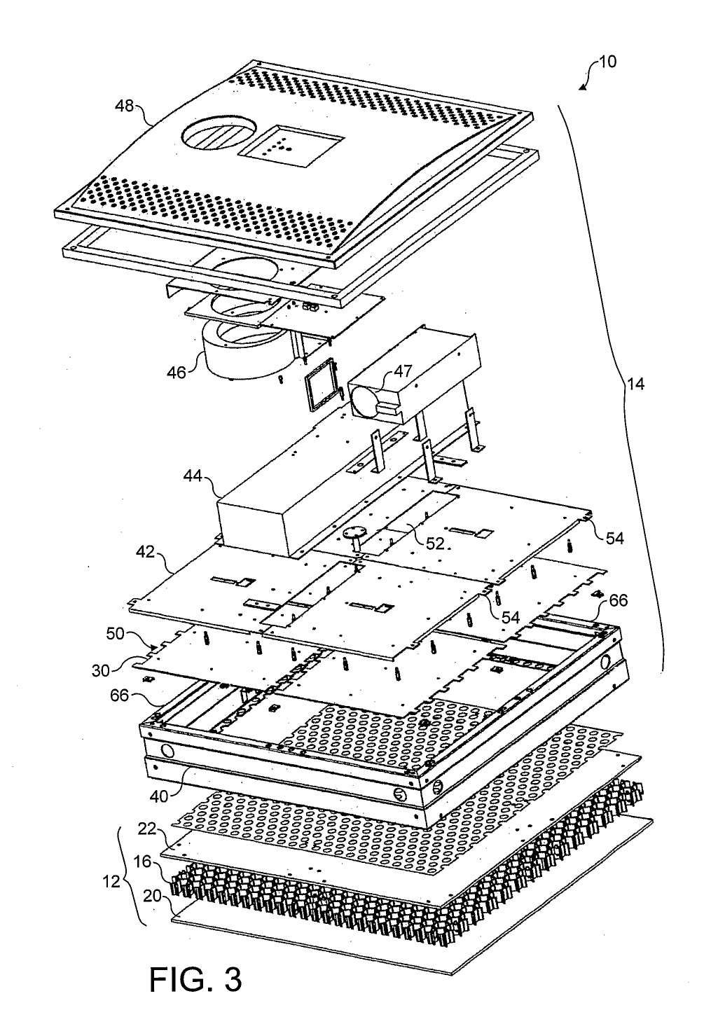

FIG. 3 is an exploded perspective view of one embodiment of a modular display system in greater detail;

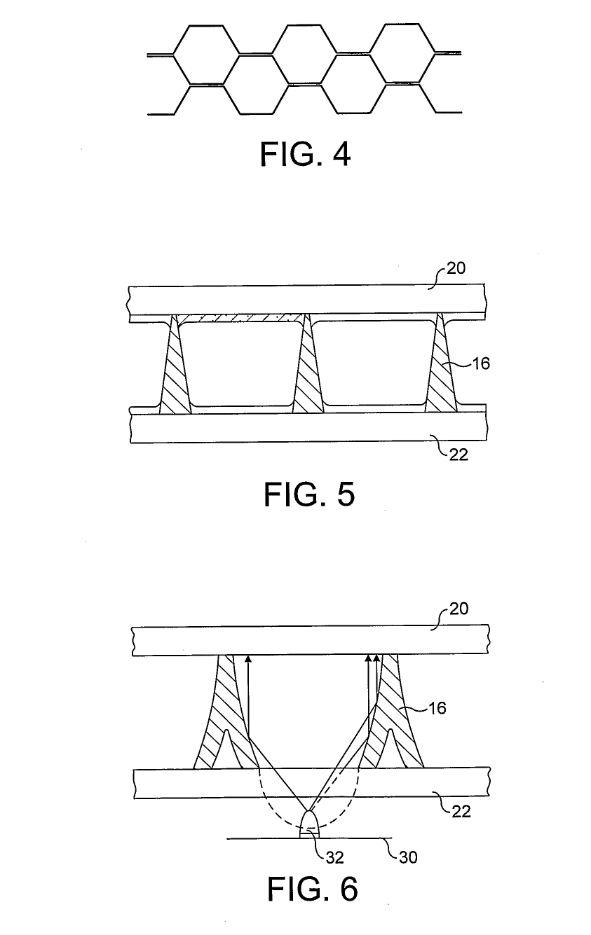

FIG. 4 is a schematic plan view showing one method of fabrication of the array of cells by joining of accurately formed strips;

FIG. 5 is a schematic cross-sectional view of a first embodiment of the fascia assembly;

FIG. 6 is a schematic cross-sectional view of a second embodiment of the fascia assembly;

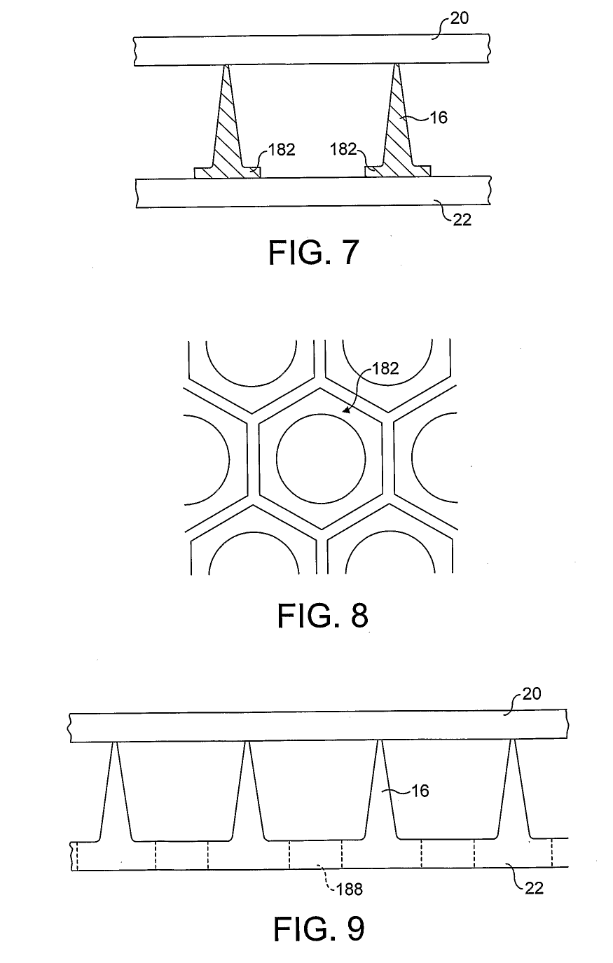

FIG. 7 is a schematic cross-sectional view of a third embodiment of the fascia assembly;

FIG. 8 is a plan view of the array of FIG. 7;

FIG. 9 is a schematic cross-sectional view of a fourth embodiment of the fascia assembly;

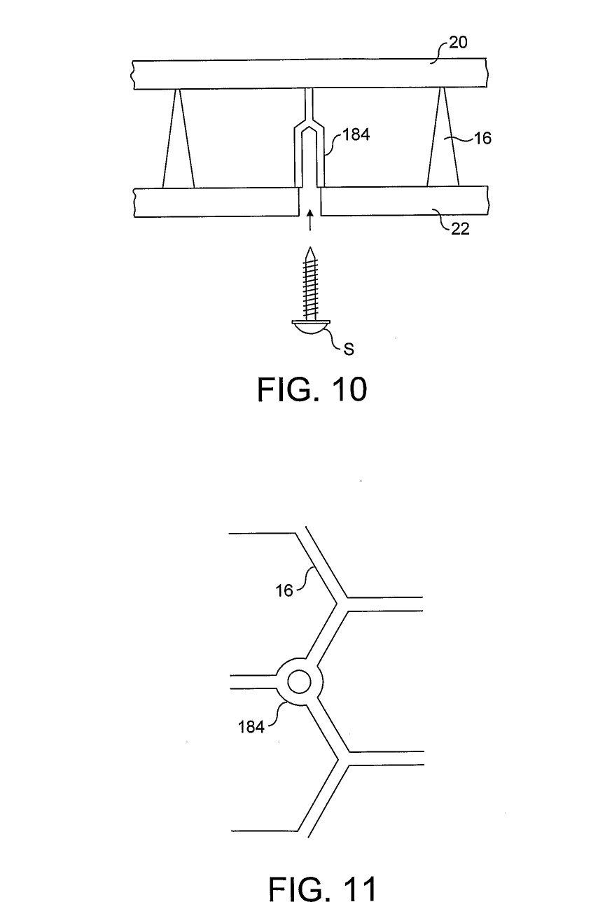

FIG. 10 is a schematic cross-sectional view of fifth embodiment of the fascia assembly;

FIG. 11 is an underneath plan view of the array of FIG. 10;

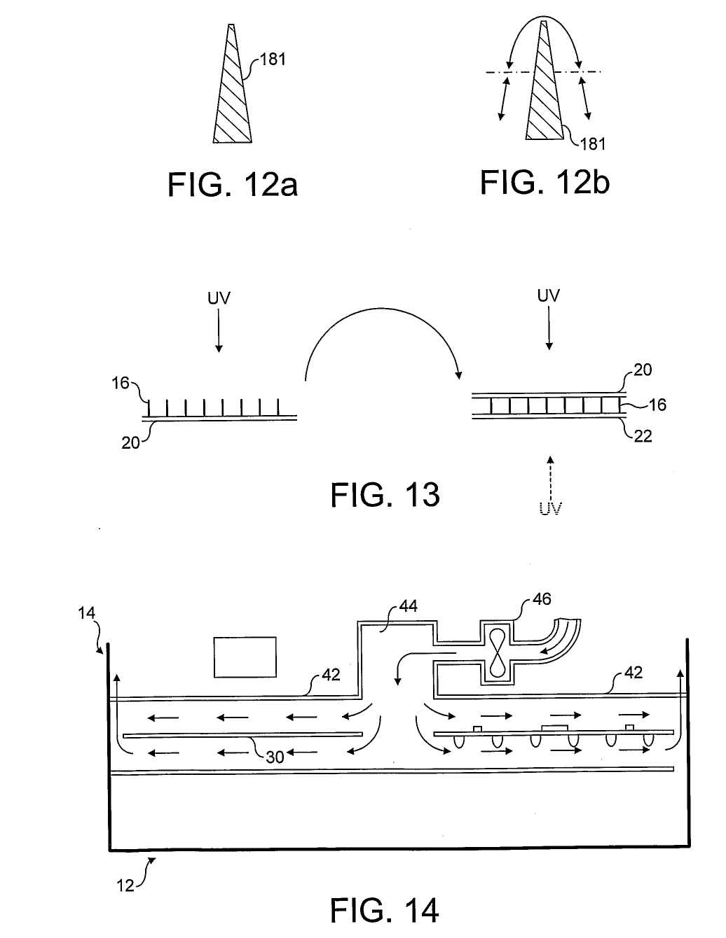

FIGS. 12a and 12b are cross-sectional views of one wall of a cell, showing the areas which may be coated;

FIG. 13 illustrates schematically the manufacture of the fascia assembly;

FIG. 14 is a schematic cross-sectional view of the display element of FIG. 3 illustrating the cooling means;

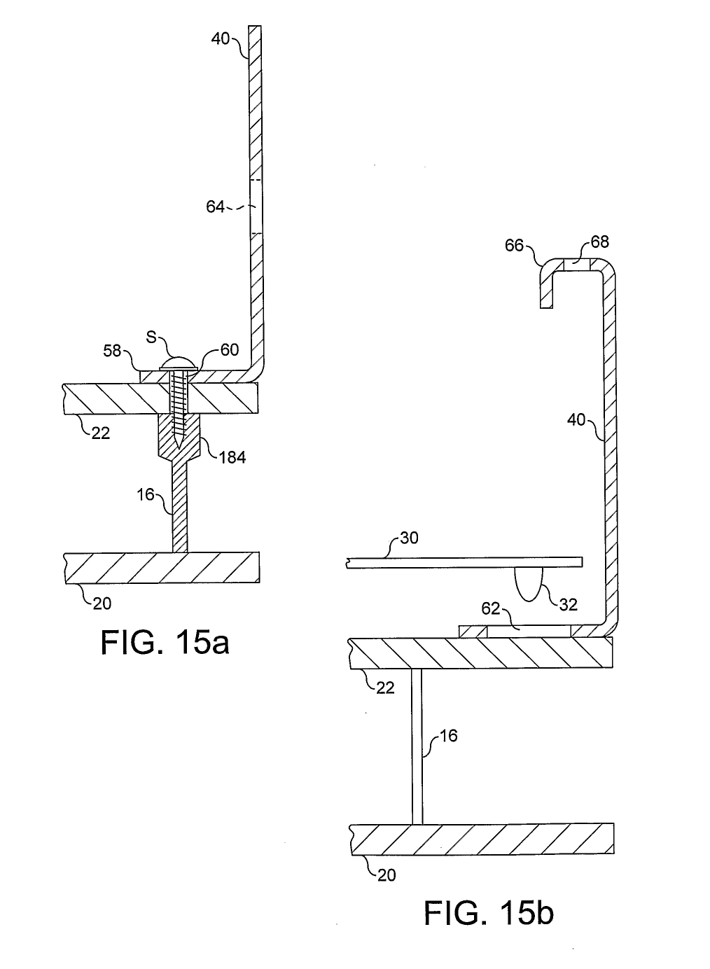

FIGS. 15a and 15b are schematic cross-sectional views of part of the perimeter frame of the display system of FIG. 3;

FIG. 16 illustrates the edges of adjacent fascia assemblies;

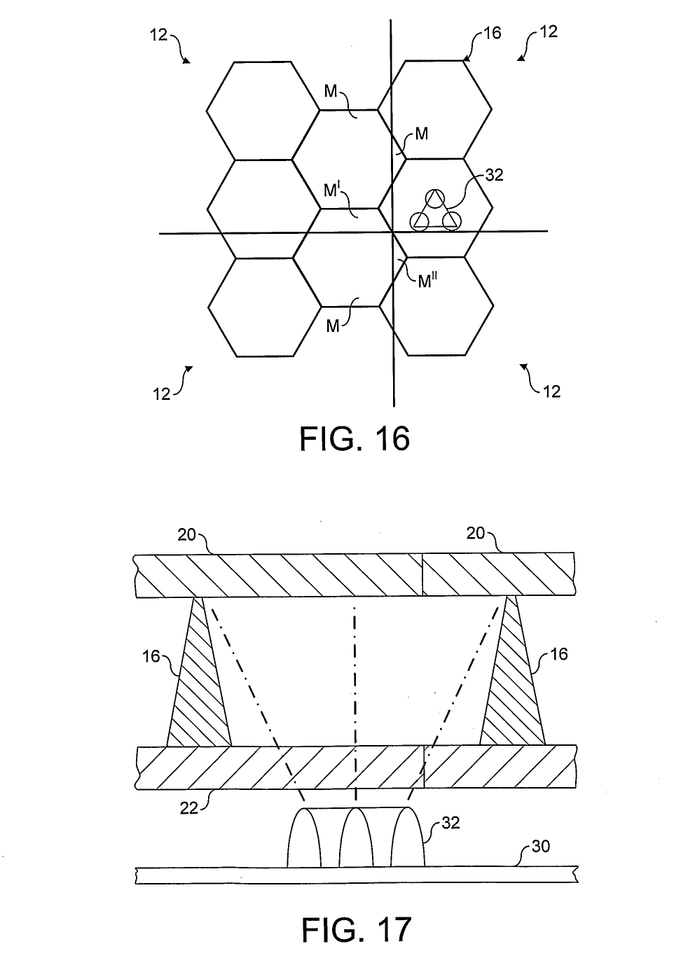

FIG. 17 illustrates the illumination of cells at the edges of adjacent fascia assemblies;

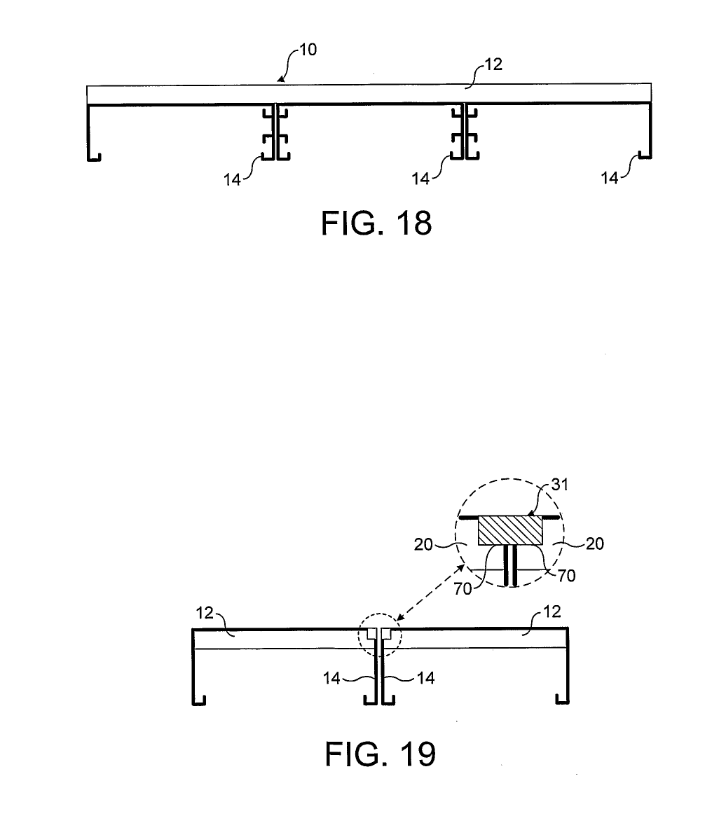

FIG. 18 illustrates a display system with a single fascia assembly and multiple illumination assemblies;

FIG. 19 illustrates a display element consisting of multiple fascia assemblies;

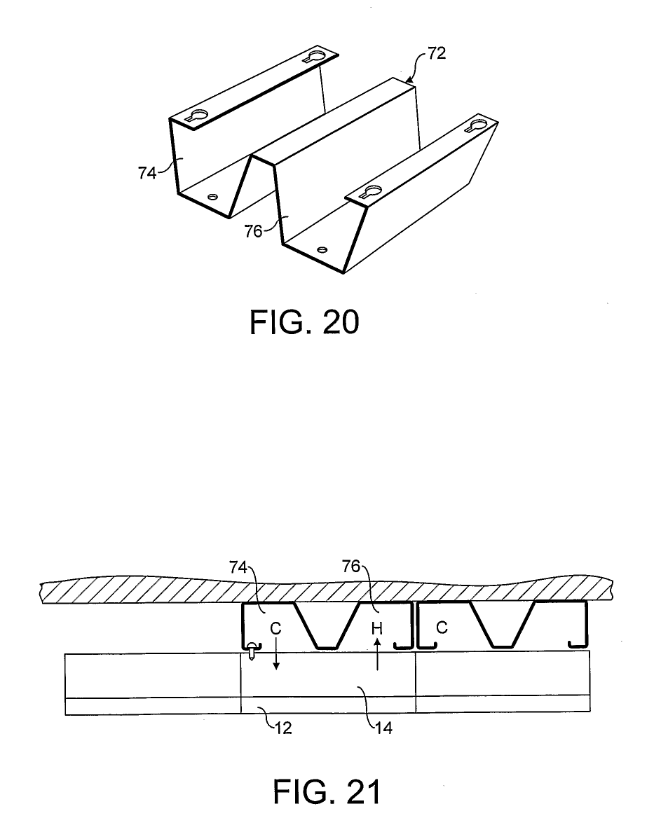

FIG. 20 is a perspective view of one embodiment of a mounting bracket; and

FIG. 21 is a plan view of the bracket of FIG. 20 in use.

FIG. 1 shows a perspective view of a portion of a modular display system in accordance with a first embodiment of the present invention, in schematic form only. A portion of the system is shown in greater detail in FIG. 3. The system 10 comprises one or more fascia assemblies 12 and one or more illumination assemblies 14. These are essentially self-contained units, manufactured and installed separately. As described further below, each fascia assembly 12 provides an array of cells which are in the form of tubes through which light can pass. Each illumination assembly 14 comprises one or more printed circuit boards (PCBs) carrying an array of discrete light sources, each directing light through one cell, and associated drive circuitry (integrated or otherwise).

The fascia and illumination assemblies 12, 14 are made to a desired convenient unit size and a display can then be built up in multiples of these units. Typically, it may be easier to manufacture and install larger fascia assemblies 12 with a greater number of smaller illumination assemblies 14. For example, for a very large system where a display area of 2.4 m by 2.7 m is required, fascia assemblies may be made with a unit size of 2.4 m×0.9 m, thus requiring three units for the full display area. However, the illumination assemblies may be smaller units, for example 0.6 m×0.9 m and thus each fascia assembly requires four illumination assemblies. However, for a smaller or irregularly shaped display area it may be more convenient to have smaller fascia assemblies cut to a specific shape, for example to provide curved edges to a display area, whereby one illumination assembly serves a number of fascia assemblies.

### Fascia Assembly

Each fascia assembly 12 itself comprises an array 16 of cells 18, which are open at each end, sandwiched between protective front and rear panels 20 and 22.

In a preferred embodiment, the array 16 is in the form of a honeycomb providing a plurality of regular hexagonal cells 18. However, the array 16 may be formed of cells 18 of other shapes such as equilateral triangles, squares or rectangles in a grid pattern or an offset brick pattern, circular and so on.

It is known in the field of composite materials to include a honeycomb layer which is formed from a number of aluminium strips spot welded at intervals and expanded out to form the hexagonal cells. However, this does not produce even, accurately dimensioned cells. Typically, the pitch of the cells can be accurately controlled in one direction but cannot be accurately controlled in the perpendicular direction.

Consequently, for the fascia assembly 12 of the present invention, it is preferred to form the array 16 from an opaque plastics material, such as polycarbonate or ABS, by an accurate, repeatable and consistent forming process such as injection moulding, extrusion or casting. Another alternative manufacturing method is fabrication of accurate strips defining half hexagons, which can be bonded together, for example by adhesive, welding, etc to build up an array of hexagonal cells as indicated schematically in FIG. 4. The strips themselves may be produced by injection moulding, extrusion or casting.

Forming the array 16 by these methods gives a number of advantages. The dimensions of the cells 18 are accurate. Therefore, in the finished display system 10, the cells 18 will be properly aligned with the light source 32 of the illumination assembly 14. This makes manufacture and installation easier and improves appearance and the performance of the finished display system 10.

Such forming processes will give the cells 18 thicker walls 181 than if an expanded metal mesh is used, but this presents no significant disadvantage. For ease of manufacture, a mould or cast array 16 may have walls 181 which taper, for example from approximately 2 mm thick to approximately 1.3 mm thick. In use, the array 16 will be installed with the walls narrowing from the rear to the front of the fascia assembly 12 as seen in FIG. 5.

In addition, the accurate forming processes mentioned above allow for the walls 181 of the cells 18 to be formed curved, preferably as part of a parabola. The curvature can be chosen so that in the finished display system, the light source 32 is located at the centre of the parabolic curve, as shown by the dotted lines in FIG. 6. In this way, the shape of the walls 181 tends to collimate the light produced to create an essentially parallel beam.

Another opportunity presented by accurate forming processes is to create cells 18 with a flange 182 around the lower edge of the walls 181 of the cells 18 as in FIG. 7. This defines a circular opening at the base of each cell 18 as shown in FIG. 8, which limits the entrance aperture to the cell and so negates the need for a separate mask (the function of which is described further below). An extension of this principle is to form the array 16 of cells 18 integrally with the rear panel 22 as in FIG. 9. Apertures 188 can then be cut into each cell 18 as indicated by the dotted lines to allow for passage of light from the illumination assembly 14. This reduces the overall part count of the display system and simplifies manufacture.

Yet another advantage of an accurate forming process is that bosses 184 to allow mechanical fastening of the array 16 to the front and rear panels 20, 22 can be created as an integral part of the array 16, as shown in FIGS. 10 and 11. A screw S may self tap into the interior walls of the boss 184 or the boss 184 may be fitted with an insert (not shown) to receive the screw S.

The bosses 184 may extend only part of the way through the depth of the cells 18 as shown, so that the bosses 184 are in the rear portion and are barely visible from the front of the finished fascia assembly 12. Alternatively, cylindrical bosses 184 may extend the full depth of each array 16, thereby providing means to receive mechanical fasteners for both the front and rear panels 20, 22. Mechanical fasteners could then be used in addition to, or even in place of, adhesive fastening between the front and rear panels 20, 22 and the array 16.

When the array 16 is formed of a plastics material such as polycarbonate or ABS it will typically have black or dark-coloured cell walls 181. However, it may be desirable to for at least part of walls of each cell 18 to be shiny and highly reflective. Using reflective walls provides a high angle of visibility to the display, almost to 180°, so that displayed images can be seen clearly by an observer standing well to one side of the display as well as an observer facing the display head on. Using non-reflective walls gives higher contrast between cells 18. This reduces the brightness of the display; this leads to a smaller viewing angle but gives a clearer image with better definition.

If it is desired that the walls 181 of cells 18 should be highly reflective, a preferred option is to coat the walls 181 for example with a vacuum deposited aluminium layer, or an electroplated layer. The coating may provide a full gloss finish, or if is it applied to a wall surface already slightly roughened, it can provide a finish that will encourage diffusion of light, depending upon the effect desired. Typically, the coating will cover the whole interior surface of each cell 18 as shown in FIG. 12a. However, the top surface of the array 16 which faces an observer through the front panel 20 in the finished fascia assembly 12 may not be coated. Instead, it may be left its natural colour or it may be specifically blackened for example by a screen printing process. This provides a good definition between cells 18 to maximise the contrast ratio. The blacker a cell appears when it is not illuminated, the brighter it will appear when it is illuminated. To further enhance this effect, the upper portion of the walls 181 of each cell 18 may also be left uncoated or blackened, with only the lower portion silvered as in FIG. 12b

The front and rear panels 20 and 22 of the fascia assembly 12 are preferably both made of the same material to avoid any thermal distortion effects in use, although in certain applications different materials may be desired. The panels 20, 22 need to be at least translucent and preferably transparent, as well as stiff and strong to provide structural rigidity to the fascia assembly 12. Therefore, they are preferably formed from material such as a transparent polycarbonate or toughened glass, typically in the order of 5 mm thick. The array 16 is in the order of 10 to 25 mm thick such that the whole fascia assembly 12 is in the order of 20 to 35 mm thick.

The front and rear panels 20, 22 are secured to the array 16, preferably by adhesive 24 (although mechanical fasteners may be used, as discussed above). This may be a sprayed or rolled-on wet adhesive or a thin film adhesive sheet. The surface of the front panel 20 adjacent the array 16 is preferably provided with a light diffusing layer to diffuse light which passes through the fascia assembly 12 from the illumination assembly 14. In a preferred embodiment, the light diffusing layer is formed of synthetic onyx suspended in a resin, such as an acrylic resin, an epoxy resin, a polyester resin or a UV cured resin. A UV cured acrylate adhesive is the preferred option, since it is optically clear and stable light, so that it does not yellow with exposure. Furthermore, it cures in a matter of seconds upon exposure to UV light, providing a fast manufacturing process. The light diffusing layer may be applied separately to the adhesive or the two may be mixed first and then applied to the front panel 20.

During manufacture as illustrated in FIG. 13, the array 16 is pressed down onto the front panel 20 and in so doing the diffusion/adhesive layer 24 forms a slight meniscus 25, as best seen in FIG. 2 i.e. a surface which is typically concave with respect to the front panel 20, and which extends across the end of each cell 18. This creates a form of lens which further diffuses light passing through the cell 18. However, the surface of the light diffusing layer may be flat, convex or some other complex surface shape.

UV light is applied to the assembly to cure the resin, thereby securing the front panel 20 to the array 16. Once the array 16 and the front sheet 20 are secured together they are inverted and pressed down on the rear sheet 22, which has also been coated with the same adhesive. UV light is applied through the front panel 20 and the array 16 to cure the adhesive between the array 16 and the rear panel 22. Although the majority of the UV light, perhaps up to 95%, is absorbed by the already-cured resin 24 between the front panel 22 and the array 16, the small amount of UV light which does get through is nevertheless sufficient to cure the second layer of resin 24 between the array 16 and the rear panel 22. However, as an alternative it would also be possible to provide UV lighting from the underside of the rear panel 22 in order to cure the resin of that panel, as indicated by the dotted lines in FIG. 13.

As described further below, the illumination assembly 14 provides a plurality of discrete light sources, each of which is aligned with a cell 18 of the fascia assembly 12 in the finished display system. To prevent, or to reduce the amount of, any light bleeding from one cell 18 to adjacent cells mask 26 may be provided between the rear sheet 22 and the illumination assembly 12, as shown in FIGS. 2 and 3.

This mask 26 may be in a form of an ink silk screen print on the rear surface of the rear panel 22, with apertures 28 in the ink layer aligned with each cell 18. The ink is preferably black, but could be another dark colour. Black ensures a good contrast, giving a cell a black appearance when that cell's light source is switched off. Other dark colours will also achieve a good contrast but will give the display a different coloured appearance when the light sources are switched off.

Alternatively, the mask 26 could be a separate sheet of perforated material located adjacent the rear surface of the rear panel 22 and having apertures 28 aligned with each cell 18, as shown in FIG. 3.

Preferably, the apertures 28 are circular although other shapes could be used. The diameter of each aperture 28 may be selected to maximise the amount of light from the light source entering the cell 18 and hitting the light diffusing layer, whilst preventing light from one light source entering an adjacent cell. In this case, the mask 26 is preferably arranged so that the beam of light passing through the aperture 28 fills the front end face of the cell 18, i.e. the area shown between arrows A in FIG. 2.

Alternatively, the apertures 28 may be sized to deliberately allow some light to bleed into adjacent cells 18. The reason for this is that if one light source fails, its associated cell will appear black (or at least dark) and this “dead cell” may be unsightly in the overall display. By allowing some light bleed between adjacent cells this effect is mitigated because some light still passes through the dead cell and it does not look so dark. The light coming from the adjacent cells typically provides a reasonable approximation of the colour the dead cell should have been. This makes any dead cells less obvious and softens cell edges by providing a degree of colour mixing. Nevertheless, the diameter of the apertures 28, and hence the amount of light bleed, should not be too great in case a light source is actually intended to be off to provide a dark cell.

### Illumination Assembly

Each illumination assembly 14 comprises one or more circuit boards 30 carrying an array of discrete light sources 32, preferably LEDs, but optionally OLEDs, light bulbs, or other discrete light sources and processing means 34 for controlling the light sources 32.

In the preferred embodiment shown in FIG. 3, each illumination assembly 14 consists of four PCBs 30 mounted within a perimeter frame 40. The perimeter frame 40 also holds cooling means for cooling the light sources 32, comprising a diaphragm plate assembly 42, a plenum chamber 44, a fan 46 with a power source and controller 47 and a rear cover plate 48.

The diaphragm plate assembly 42 provides a physical barrier between the hotter forward part of the illumination assembly 14 which contains the PCBs 30 and light sources 32 and the cooler, rearward part of the assembly 14. In this example, the diaphragm plate assembly 42 is made up of four individual plates, for ease of manufacture. Each plate has a rectangular cut out in one edge. Pairs of plates can be fitted together with these cut outs facing one another to provide a slot 52 through the diaphragm plate assembly 42. On the opposite edges of each plate, projecting tabs 54 are provided for fixing the diaphragm plate within the perimeter frame 40 with an air gap remaining between the frame 40 and the plate.

Each light source 32 may be a surface mounted full colour LED, i.e. a combined unit usually having one red, one green and two blue light emitting diodes, which is able to produce white light in combination, or separate red, green or blue LEDs in a tight cluster. Alternatively, single colour or white LEDs could be used, to provide a monochrome display. The light sources 32 are arranged in a suitable grid pattern so that when combined with a fascia assembly 12, each light source 32 will be aligned with a cell 18.

When fascia and illumination assemblies 12, 14 are installed to create a display system, an air gap 36 of typically 5 mm is left between the rear sheet 22 and the circuit board 30 as shown in FIG. 2. As well as simplifying installation, this gap allows cooling of the illumination assembly 14. Light sources 32 such as LEDs generate significant heat but it is preferred to keep them within a temperature range of approximately 50 to 75NC to maximise their life.

As shown in FIG. 3, the edges of at least two opposing sides of each PCB 30 are cut away between the LEDs in the edge most row, to create a dog-tooth or castellated form. The gaps 50 thus formed in the edges of the PCBs 30 allow air to circulate between the front and rear of the PCB

As illustrated in FIG. 14, cooling air is provided by a fan 46 which supplies air to the plenum chamber 44 mounted on the rear of the diaphragm plate assembly 42 overlying the slots 52. As the air in the plenum chamber is slightly pressurised by the action of the fan 46 it flows through the slots 52 and the gaps 50 provided by the dog tooth inner edges of the PCBs 30 across the front and rear of the PCBs in order to cool the light sources 32. The air escapes through the dog tooth gaps 50 in the outer edges of the PCBs 30 and between the edges of the diaphragm plate assembly 42 and the perimeter frame 40 and ultimately vents to atmosphere through apertures 56 in the rear cover plate 48. The fan 46 is operated by a power source and controller 47 also contained with the illumination assembly 14. Temperature sensors (not shown) may also be provided so that the fan 46 need only be operated as and when required.

The perimeter frame 40 of each illumination assembly 14 is formed from a strong but lightweight material, such as aluminium or steel. As seen in the cross-sectional views of FIGS. 15a and 15b, it is provided with a front flange 58 for attachment of the illumination assembly 14 to a fascia assembly 12. The front flange 58 is perforated by smaller apertures 60 to receive mechanical fastening means such as screws S. At appropriate intervals, it is also perforated by larger apertures 62 aligned with the edgemost row of light sources 32 on the PCBs 30 to allow the light sources 32 to be used right up to the very edge of the illumination assembly 14.

The side walls of the perimeter frame 40 are also provided with apertures 64 for fastening of adjacent illumination assemblies 14 together, to build up a large display system.

Finally, the perimeter frame 40 is provided with a rear flange 66 with apertures 68 for attachment of the rear cover 48 and possibly also for attachment of the illumination assembly to another structure such as a wall or mounting bracket, as described further below.

### Display System

In use, a display system 10 in accordance with the present invention is created by combining one or more fascia assemblies 12 with one or more illumination assemblies 14. As mentioned above, a number of illumination assemblies 14 can be connected together to build up a large display area. These can provide illumination for a single fascia assembly 12 covering all of the illumination assemblies 14, or for a number of fascia assemblies 12.

To provide a large display area, it is of course desirable that the image is coherent across the whole display area and is not disrupted by the edges of multiple units making up the display. The construction of the fascia assemblies 12 and illumination assemblies 14 of the present invention allows effectively seamless joints, and thus continuity of the image across the whole display area.

At the edges of each fascia assembly 12, the cells 18 are cut along a line which bisects either two adjacent sides of each hexagon, or two opposing, non-parallel sides of the hexagon as shown in FIG. 16. In this way, the cells 18 are cut into a major portion M and a minor portion m. At the corner of a fascia assembly, a cell may be cut into a major portion M and two minor portions m′ and m″ as shown. The location of the light source 32 aligned with each cell 18 is not interfered with. Adjacent fascia assemblies 12 fit together seamlessly, with the major portion M of a cell 18 in one fascia assembly 12 combining with the minor portion(s) m of a corresponding cell 18 from the (or each) adjacent fascia assembly 12 to recreate a whole cell 18. The light source 32 aligned with the major portion M of one cut cell 18 also acts to illuminate the minor portions m of the adjoining cut cell 18 provided by the adjacent fascia assembly 12 as shown in FIG. 17. Therefore, provided each edge of each fascia assembly 12 is cut in the same manner, no alteration to the positioning of the light source 32 is required and a seamless display is achieved.

In use, a number of fascia and illumination assemblies 12, 14 may be built up to create a display which may be a stand alone unit, or a separate assembly for mounting on an existing structure. Alternatively, the display system may be physically incorporated into the structure itself, so that it forms an integral part of, for example, an internal or external wall.

The display system 10 can be used externally, with the fascia assembly 12 providing weatherproofing for the system. One continuous assembly 12 may be used, with a number of illumination assemblies 14 behind it as shown in FIG. 18. Alternatively, if it is necessary to use a number of fascia assemblies 12, they can be joined and weatherproofed by means of a simple silicon seal in a rebate 70 formed in the edges of the front panel 20 as shown in FIG. 19.

If the display system 10 is to be mounted on an existing structure, it may be necessary to use a mounting bracket which spaces the rear of the illumination assembly 14 from the structure to allow for cooling air to be drawn in by the fan 46 and for hot air to escape. A suitable bracket 72 is shown in FIG. 20. This has a roughly W-shaped profile which defines two separated channels 74 and 76. Cool air can be drawn in via channel 74 by the fan 46 and hot air is allowed to vent from the rear cover 48 to the channel 46.

Thus, the present invention provides a modular display system which is simple and cost effective to manufacture and install, and extremely flexible in terms of size and shape and the location in which it can be used whilst providing high quality imaging.

1. A modular display system comprising at least one fascia assembly comprising an array of light transmitting cells, and at least one illumination assembly comprising an array of light sources each alienable with a cell of the fascia assembly in use and a processor controlling the light sources, wherein the cells of the array are hexagonal and at the edges of the at least one fascia assembly the cells are cut along a line which bisects two adjacent, non-parallel walls of each cell, or which bisects two opposite, non-parallel walls of each cell.

2. A modular display system as claimed in claim 1, wherein the array of cells is produced by moulding, casting or extrusion.

3. A modular display system as claimed in claim 2, wherein the array of cells is integrally formed with fastening means on at least one side to facilitate attachment of the array of cells to other elements.

4. A modular display system as claimed in claim 2, wherein the array of cells is integrally formed with one or more bosses on at least one side for receiving a mechanical fastener.

5. A modular display system as claimed in claim 2 wherein the array of cells is integrally formed with one or more bosses on both sides of the array for receiving a mechanical fastener.

6. A modular display system as claimed in any claim 1, wherein each illumination assembly comprises a frame, means for supporting the array of light sources within the frame and cooling means for cooling the light sources.

7. A modular display system as claimed in claim 1, wherein each illumination assembly comprises a fan, a power source and controller for operating the fan, a plenum chamber and pathways to allow airflow from the plenum chamber, across the light sources and out of the assembly.

8. A modular display system as claimed in claim 1, wherein the at least one fascia assembly and the at least one illumination assembly are securable together to provide a load bearing structural element.

9. A modular display system as claimed in claim 1, wherein the at least one fascia assembly further comprises front and rear panels which are at least partially light transmitting, between which the array of cells is located.

10. A modular display system as claimed in claim 9, wherein the rear and front panels are secured to the array of cells by a UV-cured adhesive.

11. (canceled)
